(19) United States
(12) Patent Application Publication
(10) Pub. No.: US 2009/0152487 A1
(43) Pub. Date: Jun. 18, 2009

(54) Quick actuator

(76) Inventor: Randy Joe Soterhou, Humble, TX (US)

Correspondence Address: Randy Soterhou, 11807 Misty Peak Ln, Humble, TX, 77346, US

(21) Appl. No.: 12/286,833

(22) Filed: Oct. 1, 2008

Related U.S. Application Data
(60) Provisional application No. 61/006,049, filed on Dec. 17, 2007.

(51) Int. Cl. F16K 5/06

(52) U.S. Cl. 251/315.01

(57) ABSTRACT

An actuator designed to open and close valves easier. Preferably metal, a user can engage the actuator by either a rotating means or manually by hand. Thereby making it possible to engage a stuck actuator in the event of an emergency. Its unique star patterned sleeve makes it impossible easily possible. Simply by slipping and impact gun's socket over the star patterned sleeve and engaging the impact. It's designed mainly for underwater use in the ocean, where salt water corrodes and jams virtually everything it comes in contact with. Thus will help in the prevention of a major oil spill or natural gas leak.

### CROSS REFERENCE TO RELATED APPLICATIONS

This application claims the benefit of provisional patent application Ser. No 61/006,049 filed Dec. 17, 2007 by present inventor

### FEDERALLY SPONSERED REASEARCH

Not Applicable

### SEQUENCE LISTING OR PROGRAM

Not Applicable

### BACKGROUND

1. Field of the Invention

This invention relate to the opening and closing of ball valves, through the use of an actuator.

2. Prior Art

This invention relates to the opening and closing of ball valves both underwater or on land. A ball valve is a section of a pipeline that can stop or restrict the flow of a product being carried through the pipeline. The ball inside the valve is opened or closed by the turning of an actuator from the outside of the housing. Larger size ball valves are used quite often in the oil and gas industries offshore. These ball valves can be any where from thousands of feet deep in the ocean to above sea level. My main focus here is the ball valves located in the oceans saltwater. Some of these valves have hydraulic hoses that are set up to open and close. These hoses are generally successful in the opening and closing of the valves. Using this method requires the right equipment to show up on location, which can be extremely time costly and expensive. Most ball valves have an actuator that was designed to work with them, quite often the actuator can get stuck or be extremely difficult to turn. The actuator is attached to a stem then penetrates into a gearbox to open or close the ball valve via the actuator. Lots of times the salt water will cause all of theses areas to freeze up do to rust or corrosion from saltwater, making the actuator virtually impossibly to turn. In the case of an emergency where crude oil or natural gas is spilling can have devastating results both environmentally and financially. There needs to be a way to open or close these ball valves easily and quickly.

### SUMMARY

The invention, an improved actuator which allows quick opening and closing of ball valves. The main idea behind my style actuation is using a hydraulic impact wrench, placing the wrench in the center of on the star patterned center peg. When the impact wrench is engaged the actuator will rotate freely. The actuator is built similar to older styles. The size of the actuator and star pattern center peg are all subject to change do to size of valves and customers/manufacture specifications.

### DRAWINGS

FIG. 1 is a perspective frontal view of the quick actuator.

FIG. 2 is a perspective side view of the quick actuator

### DETAILED DESCRIPTION

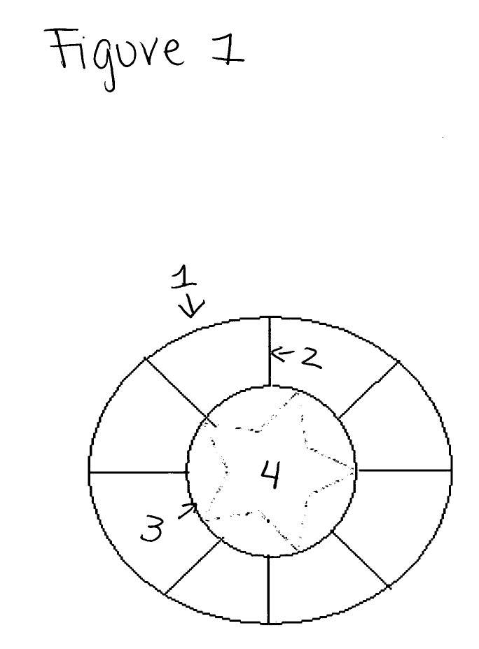

FIG. 1 is a perspective frontal view of the quick actuator. Number 1 is the outer ring of the actuator. It's made out of metal circular pole shaped to form a complete circle. Number 2 is support welded from 1 to 3. It's also made out of a metal circular rod. Number 3 is a metal plate connecting 2 to 4, it's also made out of metal, Number 4 is the star patterned sleeve. It is welded to number 3. All numbers are subject to change in size do to valve size. Most actuators will be made generally out of steel, but also may be made out of others products. I've envisioned a star pattered sleeve in the center but the shape of number 4 may be changed.

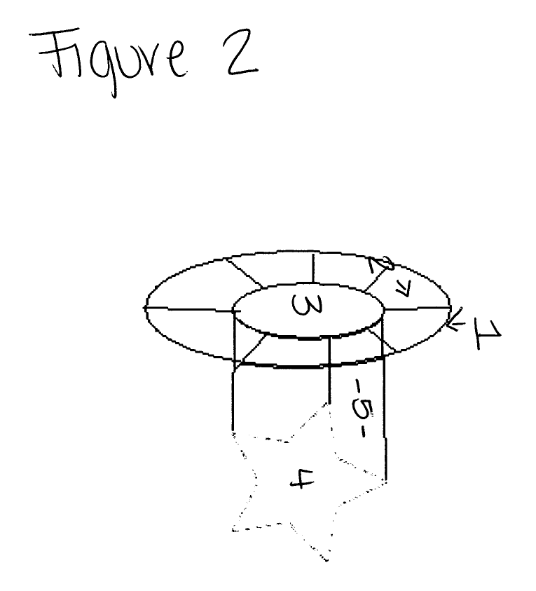

FIG. 2 is a perspective side view of the quick actuator. Numbers 14 are all the same as FIG. 1. Number 5 shows the star patterned sleeve petrudes out from number 3.

### Operation

When using this actuator, it is required to slide an impact gun's socket over the star patterned sleeve. Engage the impact gun and start rotating the actuator. In case of an equipment failure the actuator may still be tuned by hand in case of an emergency.

### Conclusion, Ramifications, and Scope

Accordingly, the reader can see that the Quick Actuator closures of the various embodiments can be used to open and close valves more efficiently, can help in the prevention of major spill, it can be turned either by rotating means or manually by hand. Major oil companies will want the Quick Actuator in their oil spill. It will prevent disasters and save money on paying a diving company to go underwater and operate these valves.

Although the description above contains many specificities, these should not be construded as limiting the scope of the embodiment but as merely providing illustrations of some of the presently preferred embodiments. For example, the Quick Actuator can have other shapes such as the star pattered sleeve can come in a various shapes. The Quick Actuator can be made of different types metals even plastic. The outer housing can change in shape and size according to the size needed for the valve and company requirements.

Thus the scope of the embodiment should be determined by the appended claims and their legal equivalents, rather than by example given.

1. A method for opening and closing ball valves comprising the steps of:
a. providing the use of rotating means, using the rotating means will turn the valve
b. said sliding the rotating means over the sleeve, said engaging the rotating means will rotate the actuator
c. said rotating the actuator will open/close valve
